(19) United States
(12) Patent Application Publication
(10) Pub. No.: US 2020/0005248 A1
(43) Pub. Date: Jan. 2, 2020

(54) MEETING PREPARATION MANAGER

(71) Applicant: MICROSOFT TECHNOLOGY LICENSING, LLC, Redmond, WA (US)

(72) Inventors: Adi GERZI, Tel Aviv (IL); Tomer HERMELIN, Tel Aviv (IL)

(21) Appl. No.: 16/353,395

(22) Filed: Mar. 14, 2019

Related U.S. Application Data
(60) Provisional application No. 62/692,378, filed on Jun. 29, 2018.

(51) Int. Cl. G06Q 10/10

(52) U.S. Cl. CPC G06Q 10/1095; G06Q 10/1097

(57) ABSTRACT

Aspects of this disclosure provide systems and methods for managing meeting preparation for attendees. In an aspect, preparation events are associated with upcoming meetings. The preparation events are then viewable in association with the meeting or through other preparation interfaces. The technology can determine due dates and work times for the preparation events that allow the user to complete the preparation prior to a scheduled meeting. The due dates and times can be used to surface notifications and reminders of the preparation events. If a meeting is canceled or rescheduled, the due dates for preparation events can automatically be updated.

### CROSS-REFERENCE TO RELATED DOCUMENTS

This application claims the benefit of priority to U.S. Provisional Application No. 62/692,378, filed Jun. 29, 2018, titled “Meeting Preparation Manager,” the entirety of which is hereby incorporated by reference.

### BACKGROUND

Meetings have become increasingly common in many work environments. Often, a significant amount of time is spent preparing for these meetings. Calendars make it relatively easy to set up and track the meetings. However, preparing for meetings can be a challenge. For example, a person may need to read a document, prepare slides, get feedback from stakeholders, or perform other tasks before attending a meeting. Generally, these tasks are tracked, if at all, separately from the meeting. For example, tasks could be added to task application, project management software, or through some other means.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Aspects of this disclosure provide systems and methods for managing meeting preparation for attendees. In an aspect, preparation events are associated with upcoming meetings. Preparation event reminders are then viewable in association with the meeting or through other preparation interfaces. The technology can determine due dates and work times for the preparation events that allow the user to complete the preparation prior to a scheduled meeting. The due dates and times can be used to surface notifications and reminders of the preparation events. If a meeting is canceled or rescheduled, the due dates for preparation events can be automatically updated.

### BRIEF DESCRIPTION OF THE DRAWINGS

The present disclosure is described in detail below with reference to the attached drawing figures, wherein:

FIG. 1 is a block diagram of an exemplary computing environment suitable for use in implementing embodiments of the present disclosure;

FIG. 2 is a block diagram illustrating an exemplary meeting preparation system in which some embodiments of the present disclosure may be employed;

FIG. 3 is a diagram of a meeting preparation management interface, in accordance with aspects of the technology described herein;

FIG. 4 is a diagram of a meeting preparation management interface, in accordance with aspects of the technology described herein;

FIG. 5 is a flow diagram that illustrates a method for organizing meeting preparation, in accordance with aspects of the technology described herein;

FIG. 6 is a flow diagram that illustrates a method for organizing meeting preparation, in accordance with aspects of the technology described herein;

FIG. 7 is a flow diagram that illustrates a method for organizing meeting preparation, in accordance with aspects of the technology described herein;

FIG. 8 is a block diagram that illustrates an exemplary computing device; and

FIG. 9 is a diagram of a meeting preparation interface, in accordance with aspects of the technology described herein.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

Aspects of this disclosure provide systems and methods for managing meeting preparation for attendees. In an aspect, preparation events are associated with upcoming meetings. The preparation events are then viewable in association with the meeting or through other preparation interfaces. The technology can determine due dates and work times for the preparation events that allow the user to complete the preparation prior to a scheduled meeting. The due dates and times can be used to surface notifications and reminders of the preparation events. If a meeting is canceled or rescheduled, the due dates for preparation events can automatically be updated.

Preparation events include tasks, commitments, and requests. Tasks, commitments, and requests all relate to an action to be taken. The primary difference between tasks, commitments, and requests is how they are generated. Tasks are explicitly created by a user in a task interface. A user may create a task for himself or for one or more other users. Typically, the task record will include a due date and other information about the task directly provided by the user. Task records can be built as part of project management software, communication applications, enterprise applications, personal assistant applications, and other special purpose applications. Task records can be built within applications that also include calendars. However, for purposes of this disclosure, a task record is not directly linked to a calendar entry. Text within the task record may mention a meeting that occurred or will occur in the future. The technology described herein, can associate a task that is not explicitly associated with a meeting to the meeting.

Commitments and requests are derived from unstructured communications, such as text and email. In contrast to explicitly created tasks, the commitments and requests are inferred from communications. As used herein, “unstructured communications” are communications without a schema for communicating task information. For example, many airlines use a schema to communicate ticket or reservation information. The schema may be explicitly provided by the author of the email (e.g., in the case of schema.org) or be clearly identifiable from the email (e.g., using HTML tags and layout information). The airline communications are structured. Unstructured communications can be written in natural language form and can be processed using natural language processing techniques.

The requests may be made by the user or of the user. For example, a user may request that a co-worker send him financial figures for the meeting or the co-worker may request that the user send him financial figures for the meeting. Similarly, the commitments may be made by the user or to the user by another person. For example, a user may commit to complete a project or the user may receive a commitment from another person to complete a project. Either way, the commitments and requests can be associated with the user and tracked. Many of the examples used herein describe the user making a commitment or receiving a request, but the technology can apply equally to the user making a request or receiving a commitment. Tasks, commitments, and requests are used as example preparation events, herein.

At a high level, meeting preparation patterns are identified by finding relationships between meetings and user actions before the meeting. For example, user data may be monitored in order to identify meetings that have been conducted and to determine features associated with the meetings and preparations that were made leading up to the meeting. The goal is to build preparation patterns for different types of meetings, where the meetings type is defined by its features. Once established, the preparation patterns can be used to associate observed preparation tasks with an upcoming meeting and create preparation events. Preparation tasks include explicitly created tasks entries, requests, and commitments. Created preparation events are derived from past actions. For example, a task to request that an AV technician be called to set up a virtual conference can be created automatically when a new meeting is set up with multiple conference rooms designated as the location. The “call technician task” is created based on a pattern of requesting a technician before past meetings with multiple locations.

Some features may be detected from related meeting data, such as a meeting invitation, or other correspondence associated with the meeting. By way of example, features relating to a time and day of the meeting, a meeting subject, a meeting organizer, attendees, invitees, among others, may be detected from the meeting invitation. Other features, however, may be derived from data that is sensed, recorded, or tracked during a meeting. In one example, the sensed data may include audio or video recording(s) of the meeting, which may be converted into text in order to deduce meeting features. Continuing with this example, the text may be analyzed to determine meeting features such as, without limitation, topics discussed, an identification of a presenter or contributor, an amount of time that the presenter or other meeting participant spoke. Location data from phones can be monitored to determine who attended.

Aspects of the technology associate preparation events with individual meetings. As a first step, preparation events can be identified independently of any particular meeting. For example, tasks from one or more applications that track tasks can be identified. Communications can be monitored and analyzed to identify commitments and requests. The collected tasks, commitments, and requests can form a group of potential preparation events. In aspects, the potential preparation events can be output to users apart from any meetings.

The plurality of potential preparation events can be analyzed to determine which are associated with meetings and which are not. The potential preparation events that are associated with meetings are actual preparation events. The features of the preparation events, including the person that performed it, the device on which the event was performed, the time it takes to perform the event, the time difference between when the event was performed and a start time for an associated meeting, and such can be extracted. The features of the preparation event can be compared to the features of a meeting to associate the preparation event with a particular meeting. For example, a commitment in an email to attendees of a meeting may be associated with the meeting even though the meeting is not specifically mentioned in the email. In this example, the correlation between the meeting invitees and email recipients is used to link the commitment to the meeting. In addition to the attendees, a subject matter similarity analysis can be performed to associate an email with the meeting. For example, if keywords from the title of a meeting are found in an email then an association between the email and the meeting may be made. Having an email linked to a meeting, the commitments found in the email can be linked to the meeting. In some cases, a communication may have partial information about a meeting, such as a time or location without other meeting details. For example, a text message saying, “please mail the agenda for our 2 o'clock meeting” may be used to associate the request with a meeting occurring at 2 o'clock that has both the author and recipient of the text message.

The features of a potential preparation event can be compared to features of previous preparation events to associate a preparation event with an upcoming meeting. For example, if a particular meeting organizer frequently prepares a slide deck covering open items from a previous meeting prior to a meeting having certain features, then a task to prepare a slide deck can be associated with an upcoming meeting having similar features to the previous meetings.

The preparation patterns and meeting patterns can be mined to form rules that can be specific to an organization, group of people, or the public in general. The rules can be used to associate preparation events with a meeting.

The rules can be scenario specific. For example, certain rules can be built for reoccurring meetings. For example, the timing of an email related to a series of meetings can be used to associate a preparation event within the email to a particular meeting in the series. Using this rule a commitment in an email sent after a meeting in the series has started (i.e., you are either in the meeting or that meeting has ended), then any task/commitment in the email may be inferred to be relevant to the next meeting in the series. So if a participant emails a promise to send a meeting summary during a meeting, the technology can associate the commitment with the next meeting. Further, the due date for this commitment can be determined based on the distribution timing of previous meeting summaries in this series of meetings.

Another scenario involves using an email in a thread to generate a meeting invitation, as enabled by some current email applications. In this case, the commitments and requests in the thread can be associated with the meeting. In one aspect, a proximity threshold is used when the email thread spans more than a week of time, or some other limit In this case, only requests and commitments made within emails sent within the threshold are associated with the new meeting.

In another scenario, when an email's recipients and sender are all of the participants in an upcoming meeting, then the commitments and requests in the email are associated with the meeting.

The technology described herein can generate commitments and requests that are unique to meetings. For example, a commitment to read a document can be generated in response to a meeting request that includes the document as an attachment. This commitment can be generated even when the text of the meeting request does not mention the document or provide any other indication that the document should be read for the next meeting. The due date for this commitment can be set to just before the next meeting and a reminder can be surfaced at a time that gives the user time to read the document before the meeting. If the user reads the document prior to meeting, then the read-the-document preparation event can be closed, otherwise the reminder notification can be surfaced in a timely manner

Determining when to surface a notification that will give the reader enough time to complete preparation events in a timely manner can consider several factors. For example, the system can determine how long it will take the user to complete the preparation based on analysis of user data related to similar preparations. In the case of a document, the system can learn the user's reading speed and calculate how long it will take the user to read a document using the length of the document. The system will also look at the user's other activities to determine what portions of the day the user has available to complete the preparation. If the user has several full days of meetings, the notification may need to be surfaced two or three days prior to a scheduled meeting in order to allow time for the user to read a document.

Special meeting preparation associations can be made for one-on-one meetings. One-on-one meetings tend to have looser agendas and outstanding commitments and requests may be discussed whether they are related to a specific topic of the meeting or not. Accordingly, commitments and requests extracted from any email chain between just the two participants of a one-on-one meeting may be associated with that meeting. Once associated, the commitments and requests can be surfaced in the meeting notification or through a preparation interface.

Another rule used to associated preparation events with a meeting associates a commitment or request made in an RSVP to a meeting.

In one aspect, machine learning is used to associate a communication, and the preparation events extracted from it, with a meeting by analyzing the similarity between the communication and meeting features. A similarity score may be generated for each of several features, such as subject lines, body text, people in common, etc. In one aspect, multiple similarity scores are combined to form a final similarity score. A similarity threshold can be used to determine a communication (and preparation events associated with the communication) are associated with a meeting.

In one aspect, notifications are surfaced in a timely manner The notification formats can include: Email, pop-up, calendar, card, text, a personal assistant's morning update and the like. The notification can include information about the preparation event and information about the meeting. The notification can include content or links to content for the user to review before the meeting. For example, a link to a meeting summary the user should read can be included in the notification. In one aspect, only content relevant to preparation is linked. The relevance can be determined by actions of other meeting participants—if everyone else for the meeting is reading the same document to prep, then the technology can infer that the user should read that document too.

Content may be examined to determine an amount of time necessary for a user to prepare for the meeting. The estimated prep time may also be presented to user in a notification. The notification may include a button for the user to schedule time on user's calendar for prep, based on each prep item or total prep activity time. Pressing the button causes a calendar entry for preparation to be created on the user's calendar. The technology described herein will offer to block time for the user in the calendar to complete the tasks, auto-populating the relevant content for preparation. The block duration is determined by an estimate of how much time it will take the user to complete what he/she needs to do to complete an event (for example, we know the user has 4 pages left to read and that this specific user reads a page in 10 minutes). The time block and the ideal notification time may also consider whether user has reviewed a relevant document yet. Have they opened it, how much time have they spent on it, have they navigated to the bottom of a document. How much prep time the user has left until the meeting, given their other tasks, average work times, can all be considered when blocking time and surfacing notifications.

A notification based on a request or commitment derived from a communication can include links to emails/communications related to the commitments and preparation-materials/content. In one aspect, only content determined to me most relevant is presented.

The notifications are provided at an appropriate time, which can be based on a determination of how long it will take the user to be prepared for the event. (e.g., how long it will take the user to review content to be prepared, how long it will take the user to fulfill any commitments made regarding the event.) The technology may look at user history/patterns for how much time the user's typically prepares for a similar meeting/same subject (e.g., look at user calendar for previous meetings to see self-blocked time.) The notification technology may look at user's calendar/existing task list/commitments to determine how far out to surface a notification.

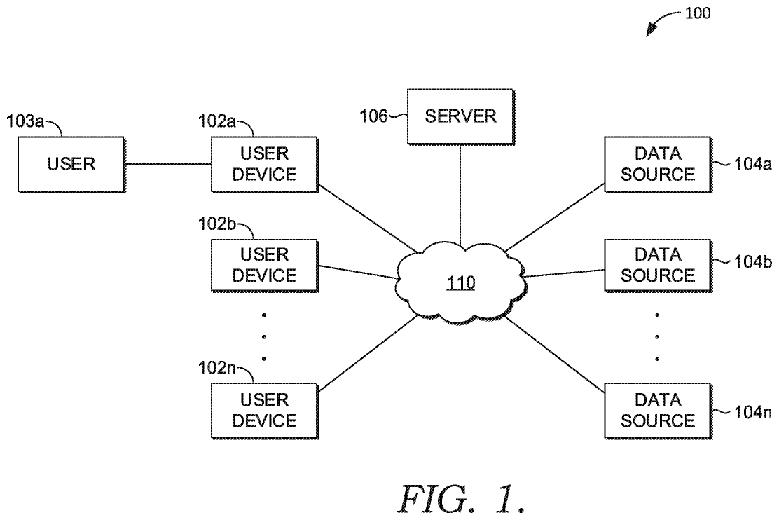

Turning now to FIG. 1, a block diagram is provided showing an operating environment 100 in which some embodiments of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

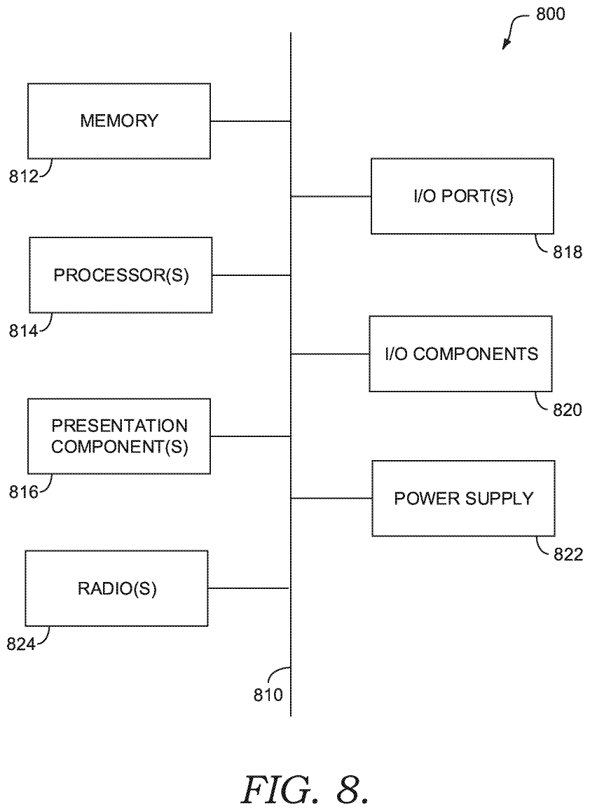

Among other components not shown, operating environment 100 includes a number of user devices, such as user devices 102a and 102b through 102n; a number of data sources, such as data sources 104a and 104b through 104n; server 106; user 103, and network 110. It should be understood that environment 100 shown in FIG. 1 is an example of one suitable operating environment. Each of the components shown in FIG. 1 may be implemented via any type of computing device, such as computing device 800, described in connection to FIG. 8, for example These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks. 100401 It should be understood that any number of user devices, servers, users, and data sources may be employed within operating environment 100 within the scope of the present disclosure. Each may comprise a single device or multiple devices cooperating in a distributed environment. For instance, server 106 maybe provided via multiple devices arranged in a distributed environment that collectively provide the functionality described herein. Additionally, other components not shown may also be included within the distributed environment.

User devices 102a and 102b through 102n may comprise any type of computing device capable of use by a user 103. For example, in one embodiment, user devices 102a through 102n may be the type of computing device described in relation to FIG. 8 herein. By way of example and not limitation, a user device may be embodied as a personal computer (PC), a laptop computer, a mobile device, a smartphone, a tablet computer, a smart watch, a wearable computer, virtual reality headset, augmented reality headset, a personal digital assistant (PDA), an MP3 player, global positioning system (GPS) or device, video player, handheld communications device, gaming device or system, entertainment system, vehicle computer system, embedded system controller, a camera, remote control, a bar code scanner, a computerized measuring device, appliance, consumer electronic device, a workstation, or any combination of these delineated devices, or any other suitable device.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities. Each user device 102a and 102b through 102n can be associated with one or more users, such as user 103. Some user devices can be associated with multiple users, such as a family PC, game console, meeting room PC, electronic white board, and such. Similarly, a single user can be associated with multiple devices, including shared devices. A user sign in identification can be used to determine the user operating a user device at a point in time and to associate actions taken with a user record.

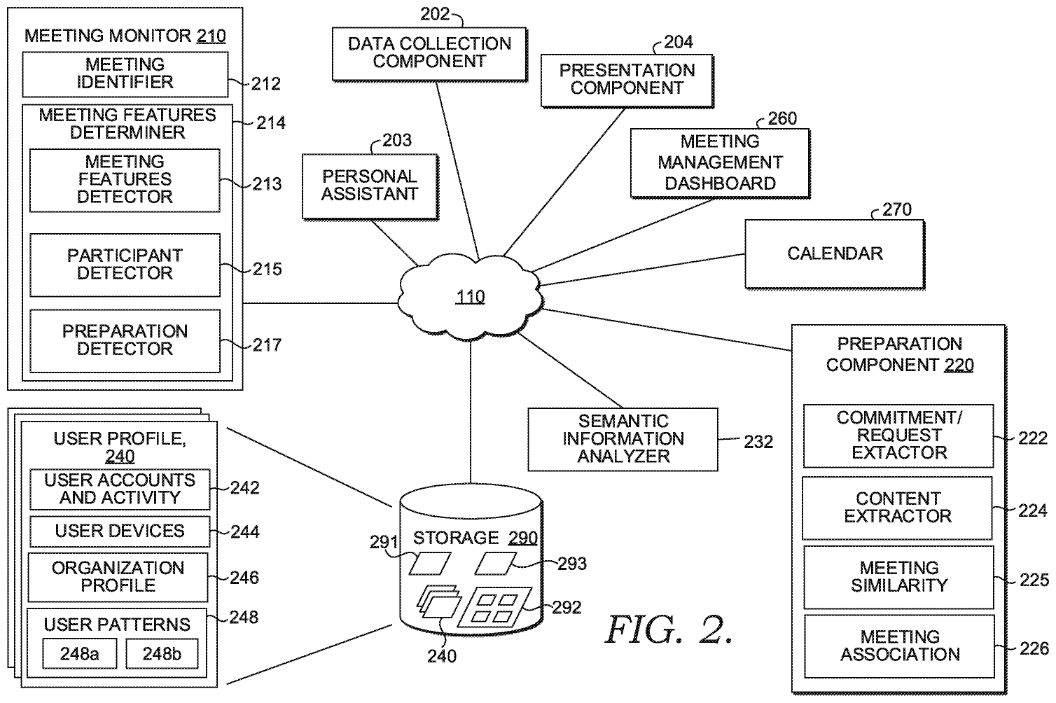

Data sources 104a and 104b through 104n may comprise data sources and/or data systems, which are configured to make data available to any of the various constituents of operating environment 100, or meeting preparation system 200 described in connection to FIG. 2. For instance, in one embodiment, one or more data sources 104a through 104n provide (or make available for accessing) data collection component 202 of FIG. 2. Data sources 104a and 104b through 104n may be discrete from user devices 102a and 102b through 102n and server 106 or may be incorporated and/or integrated into at least one of those components. In one embodiment, one or more of data sources 104a though 104n comprises one or more sensors, which may be integrated into or associated with one or more of the user device(s) 102a, 102b, or 102n or server 106. Examples of sensed meeting data made available by data sources 104a though 104n are described further in connection to data collection component 202 of FIG. 2.

Operating environment 100 can be utilized to implement one or more of the components of meeting preparation system 200, described in FIG. 2, including components for collecting user data, inferring meeting patterns, generating meeting attendance models, generating meeting details or features, learning tasks, identifying commitments and requests, and/or presenting meeting invitations and related content to users.

Turning now to FIG. 2, a block diagram is provided illustrating an exemplary meeting preparation system 200 in which some embodiments of the present disclosure may be employed. The meeting preparation system 200 includes network 110, which is described in connection to FIG. 1, and which communicatively couples components of meeting preparation system 200. The components of meeting preparation system 200 may be embodied as a set of compiled computer instructions or functions, program modules, computer software services, or an arrangement of processes carried out on one or more computer systems, such as computing device 800 described in connection to FIG. 8, for example.

In one embodiment, the functions performed by components of meeting preparation system 200 are associated with one or more personal assistant applications, services, or routines. In particular, such applications, services, or routines may operate on one or more user devices (such as data sources 104a), servers (such as server 106), may be distributed across one or more user devices and servers, or be implemented in the cloud. Moreover, in some embodiments these components of meeting preparation system 200 may be distributed across a network, including one or more servers (such as server 106) and client devices (such as user device 102a), in the cloud, or may reside on a user device such as user device 102a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments of the disclosure described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regard to specific components shown in meeting preparation system 200, it is contemplated that in some embodiments functionality of these components can be shared or distributed across other components.

As noted above, it should be understood that the meeting preparation system 200 shown in FIG. 2 is an example of one system in which embodiments of the present disclosure may be employed. Each component shown may include one or more computing devices similar to the operating environment 100 described with reference to FIG. 1. The meeting preparation system 200 should not be interpreted as having any dependency or requirement related to any single module/component or combination of modules/components illustrated therein. Each may comprise a single device or multiple devices cooperating in a distributed environment. For instance, the meeting preparation system 200 may comprise multiple devices arranged in a distributed environment that collectively provide the functionality described herein. Additionally, other components not shown may also be included within the network environment. It should be understood that the meeting preparation system 200 and/or its various components may be located anywhere in accordance with various embodiments of the present disclosure.

The meeting preparation system 200 generally operates to identify meeting preparation events (e.g., tasks, requests, and commitments), associate the preparation events with a meeting, and then present notifications to a user in a timely manner to help the user prepare for the meeting. As briefly mentioned above, each component of the meeting preparation system 200, including data collection component 202, personal assistant 203, presentation component 204, meeting preparation identifier, user profile 240, meeting preparation component 220, and meeting monitor 210, meeting management dashboard 260, calendar application 270, and their respective subcomponents, may reside on a computing device (or devices). For example, the components of meeting preparation system 200 may reside on the exemplary computing device 800 described below and shown in FIG. 8, or similar devices. Accordingly, each component of the meeting preparation system 200 may be implemented using one or more of a memory, a processors or processors, presentation components, input/output (I/O) ports and/or components, radio(s) and a power supply (e.g., as represented by reference numerals 812-824, respectively, in FIG. 8).

Data collection component 202 is generally responsible for collecting meeting data, user data, and communications, which may be made available to the other components of meeting preparation system 200. In some aspects, the data collected by the data collection component 202 includes meeting data elements (or meeting features) of meetings or events, and the data collection component 202 may be configured to associate each of the meeting data elements with a meeting, and to store the associated meeting data elements, for example, in meeting storage 292. The meeting data may include a meeting invitation, or other correspondence associated with the meeting, electronic documents included in or associated with the meeting, such as an agenda or meeting minutes, and any other meeting related data. Further, the data collection component may collect, detect, or otherwise obtain data that is sensed, recorded, or tracked during a meeting. In one example, the sensed data may include audio or video recording(s), of the meeting, which may be in a compressed, and/or a packetized format. Further, the data collection component 202 may be responsible for detecting signals corresponding to meetings and providing the detected signals to the other components of meeting preparation system 200.

In some aspects, a personal digital assistant program (PDA) 203 or similar application or service (sometimes referred to as virtual assistant), such as Microsoft Cortana®, may also be responsible for collecting, facilitating sensing, interpreting, detecting, or otherwise obtaining meeting data. PDAs that operate on a user device, across multiple user devices associated with a user, in the cloud, or a combination of these, improve user efficiency and provide personalized computing experiences. A PDA may provide some services traditionally provided by a human assistant. For example, a PDA may update a calendar, provide reminders, track activities, and perform other functions. Some PDAs can respond to voice commands and audibly communicate with users. For example, personal digital assistant 203, in one embodiment, may act as a participant in meetings in order to obtain meeting data associated with the meetings. In one aspect, data collection component 202 may access the meeting data obtained by the personal digital assistant 203 and make the meeting data available to other components of meeting preparation system 200 to determine meeting features, for example, as described in more detail with reference to meeting features determiner 214. Additionally, some embodiments of personal digital assistant 203 may perform the operations, or facilitate carrying out operations performed by, other components (or subcomponents) of systems 200.

The data collection component 202 may also be responsible for collecting, sensing, detecting, or otherwise obtaining user data. User data, which may include meeting data, may be received from a variety of sources where the data may be available in a variety of formats. For example, in some embodiments, user data received via data collection component 202 may be determined via one or more sensors, which may be on or associated with one or more user devices (such as user device 102a), servers (such as server 106), and/or other computing devices. As used herein, a sensor may include a function, routine, component, or combination thereof for sensing, detecting, or otherwise obtaining information, such as user data from a data source 104a, and may be embodied as hardware, software, or both.

Additionally, user data, particularly in the form of meeting event data and/or location data can be received by data collection component 202 from one or more computing devices associated with a user. While it is contemplated that the user data may be processed by the sensors or other components not shown, for interpretability by data collection component 202, embodiments described herein do not limit the user data to processed data and may include raw data. In some embodiments, the user data, including meeting related information, is stored in a user profile, such as user profile 240. Information about user devices associated with a user may be determined from the user data made available via data collection component 202, and may be provided to meeting monitor 210, preparation component 220, or other components of meeting preparation system 200. In some implementations of meeting monitor 210, a user device may be identified by detecting and analyzing characteristics of the user device, such as device hardware, software such as operating system (OS), network-related characteristics, user accounts accessed via the device, and similar characteristics. For example, information about a user device may be determined using functionality of many operating systems to provide information about the hardware, OS version, network connection information, installed application, or the like.

By way of example and not limitation, user data may include data that is sensed or determined from one or more sensors (referred to herein as sensor data), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other user data associated with communication events; etc.) including user activity that occurs over more than one user device, user history, session logs, application data, contacts data, calendar and schedule data, notification data, social network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personalization-related (e.g., “personal assistant,” such as Cortana®) application or service, home-sensor data, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, payment or credit card usage data (which may include information from a user's PayPal account), purchase history data (such as information from a user's Amazon.com or eBay account), other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, cellular network, or IP address data), and nearly any other source of data that may be sensed or determined as described herein. In some embodiments, user data may be provided in user-data streams or “user signals,” which can be a feed or stream of user data from a data source. For instance, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, data collection component 202 receives or accesses data continuously, periodically, or as needed.

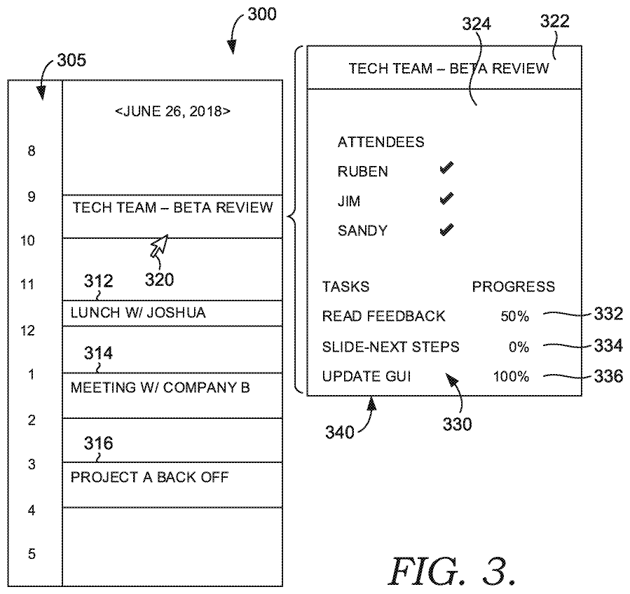

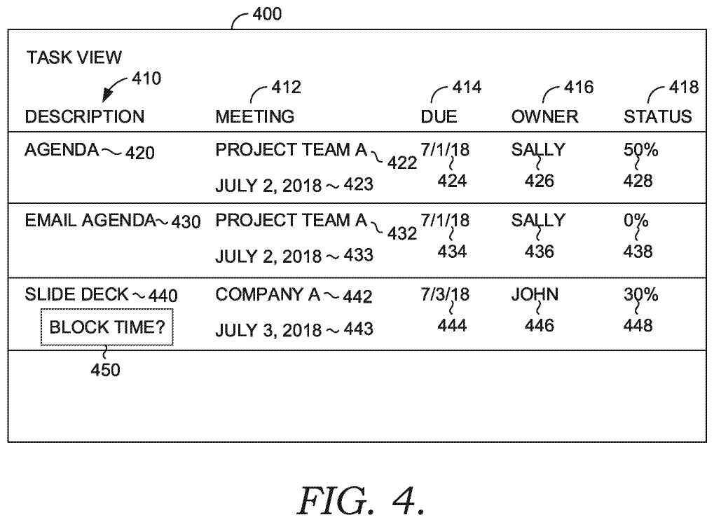

Presentation component 204 generally operates to render various user interfaces or otherwise provide information generated by the meeting preparation system 200, and the components thereof, in a format that can be displayed on a user device. By way of example, the presentation component 204 may render the meeting preparation interfaces described subsequently with reference to FIGS. 3 and 4. In some aspects, the presentation component 204 may also render a meeting preparation dashboard 260 interface.

Meeting monitor 210 is generally responsible for determining and/or detecting meeting features from meetings, and making the meeting features available to the other components of meeting preparation system 200. In some aspects, meeting monitor 210 determines and provides a set of meeting features (such as described below), for a particular meeting, and for each user associated with the meeting. In some aspects, the meeting may be a past (or historic) meeting, or a current meeting. Further, it should be appreciated that the meeting monitor 210 may be responsible for monitoring any number of meetings, for example, each meeting associated with meeting preparation system 200. Accordingly, the features corresponding to the meetings determined by meeting monitor 210 may be used to analyze a plurality of meetings and determine corresponding patterns (e.g., by inference engine 230). The meetings analyzed can be explicit meetings, such as those on a calendar, or implicit meetings, such as those tracked on a shadow calendar. Implicit meetings can be extracted from communications, location patterns, and other user data. For example, location data could be used to determine a pattern showing that a user plays golf every Friday afternoon when it is not raining An email making a promise to bring balls to the next round of golf could be mined to generate a preparation event associated with the “golf meeting.”

Meeting identifier 212, in general, is responsible for determining (or identifying) meetings that have occurred or are scheduled, associating the identified meetings with the related meeting data, and, in one aspect, providing the identified meetings and associated data to meeting features determiner 214. For example, in one embodiment, logic 291 may include comparing meeting detection criteria with the data collected by data collection component 202 and/or personal assistant 203, which may be stored in storage 290 in order to determine that a meeting has occurred or is scheduled. As can be appreciated, the meeting identifier 212 may employ meeting related data that has already been associated with a meeting, and which may be stored in meeting storage 292, in conjunction with logic 291 and data stored in storage 290 which has not been associated with a specific meeting.

In some embodiments, the identification and/or classifying of meetings can be based on feature-matching or determining similarity in features, which may be carried out using statistical classification processes Thus, logic 291 may comprise pattern recognition classifier(s), fuzzy logic, neural network, finite state machine, support vector machine, logistic regression, clustering, or machine learning techniques, similar statistical classification processes or, combinations of these to identify meetings from user data. Accordingly, the logic 291 can take many different forms depending on the mechanism used to identify a meeting, and may be stored in storage 290. For example, logic 291 might include training data used to train a neural network that evaluates user data to determine when a meeting has occurred or will occur. Moreover, logic 291 may specify types of meeting features or user activity such as specific user device interaction(s), that are associated with a meeting, accessing a schedule or calendar, accessing materials associated with a meeting (e.g. an agenda or presentation materials), composing or responding to a meeting request communication, acknowledging a notification, navigating to a website, or launching an app. In some embodiments, a series or sequence of user-related activity may be mapped to a meeting, such that the meeting may be detected upon determining that the user data indicates the series or sequence of user-related activity has occurred or been carried out by the user.

Accordingly, the meeting identifier 212 may identify a meeting and related meeting data. The related meeting data may include a meeting invitation, or other correspondence associated with the meeting, along with electronic documents included in or associated with the meeting invitation or correspondence. The related meeting data can include sensed data captured during the meeting, including shared documents, presentations, whiteboards, shared screens, audio or video recording(s) of the meeting, user activity, engagement data tracked during the meeting, and any other meeting related data.

Meeting features determiner 214 is generally responsible for determining meeting-related features (or variables) associated with the meeting, and related users, including presenters and participants. Meeting features determiner 214 may receive and analyze the related meeting data identified by meeting identifier 212 to detect, extract, and/or determine features associated with the meeting.

Meeting features detector 213 may operate to detect meeting features from the related meeting data, for example from a meeting invitation and/or documents related to the meeting. Any number of features may be detected by the meeting features detector 213 from meeting related documents, for example: time/date; scheduled duration; participants; file attachments or links in meeting-related communications; which may include content of the attachments or links; metadata associated with file attachments or links (e.g., author, version number, date, URL or website-related information, etc.); whether the meeting is recurring; and meeting features from previous meetings or future meetings (where the meeting is part of a series, such as recurring meetings). The above features are exemplary only, and are not intended to limit the features detected by meeting features detector 213.

The participant detector 215 can determine who participated in a meeting or who will participate in a scheduled meeting. As used herein, the term “participant” may include all users associated with a meeting, including users that presented or contributed during the meeting and users that spectated or observed the meeting, but did not speak or present during the meeting. Further, participants that presented, spoke, or otherwise contributed during the meeting will generally be referred to as “presenters.”

Features determiner 214 may include a presenter features determiner that generally operates to determine features related to presenters. In one aspect, a topic associated with a presenter may be determined For example, a presenter topic feature may be determined by identifying keywords from the transcript created. In another example, the presenter topic feature may be determined by analyzing specific portions of the presenter's presentation, such as a beginning and end of the presentations, which may include an overview or summary of the topic or topics discussed by the presenter. A presentation duration feature may also be determined, for example, from the recorded audio/video corresponding to the meeting. As can be appreciated, a given presenter may speak or contribute at a number of times during a given meeting. Accordingly, a speaking instances feature may be determined, which represents the number of times the presenter spoke. Further, each speaking instances may include a duration and a topic, which may be determined as described above. The presentation topics can be used to map user data, such as emails and texts to a particular meeting. Tasks, commitments, and requests can be extracted from the communications to generate preparation events.

Preparation detector 217 identifies preparation events that occurred in association with a meeting. The preparation detector can associate identified meetings with identified preparation events based on similarity, as described previously.

The preparation-event identifier 220 can perform several tasks including extraction of commitments and requests from electronic communications, such as messages between or among one or more users (e.g., a single user may send a message to oneself or to one or more other users). The preparation-event identifier 220 can associated content with meetings and preparation events and associate preparation events with particular meetings.

The commitment/request extractor 222 can extract requests and commitments from communications. For example, an email exchange between two people may include text from a first person sending a request to a second person to perform a task, and the second person making a commitment (e.g., agreeing) to perform the task. The email exchange may convey enough information for the system to automatically determine the presence of the request to perform the task and/or the commitment to perform the task. In some implementations, the email exchange does not convey enough information to determine the presence of the request and/or the commitment. Whether or not this is the case, the system may query other sources of information that may be related to one or more portions of the email exchange. For example, the system may examine other messages exchanged by one or both of the authors of the email exchange or by other people. The system may also examine larger corpora of email and other messages. Beyond other messages, the system may query a calendar or database of one or both of the authors of the email exchange for additional information. In some implementations, the system may query traffic or weather conditions at respective locations of one or both of the authors.

Herein, “extract” is used to describe determining or identifying a request or commitment in a communication. For example, a system may extract a request or commitment from a series of text messages. Here, the system is determining or identifying a request or commitment from the series of text messages, but is not necessarily removing the request or the commitment from the series of text messages. In other words, “extract” in the context used herein, unless otherwise described for particular examples, does not mean to “remove.”

Herein, a process of extracting a request and/or commitment from a communication may be described as a process of extracting “task content.” In other words, “task content” as described herein refers to one or more requests, one or more commitments, and/or projects comprising combinations of requests and commitments that are conveyed in the meaning of the communication. In various implementations, interplay between commitments and requests may be identified and extracted. Such interplay, for example, may be where a commitment to a requester generates one or more requests directed to the requester and/or third parties (e.g., individuals, groups, processing components, and so on. For example, a commitment to a request from an engineering manager to complete a production yield analysis may generate secondary requests directed to a manufacturing team for production data.

In various implementations, a process may extract a fragment of text containing a commitment or request. For example, a paragraph may include a commitment or request in the second sentence of the paragraph. Additionally, the process may extract the text fragment, sentence, or paragraph that contains the commitment or request, such as the third sentence or various word phrases in the paragraph.

In various implementations, a process may augment extracted task content (e.g., requests or commitments) with identification of people and one or more locations associated with the extracted task content. For example, an extracted request may be stored or processed with additional information, such as identification of the requester and/or “requestee(s),” pertinent location(s), times/dates, and so on.

Once identified and extracted by a computing system, task content (e.g., the proposal or affirmation of a commitment or request) of a communication may be further processed or analyzed to identify or infer semantics of the commitment or request including: identifying the primary owners of the request or commitment (e.g., if not the parties in the communication); the nature of the task content and its properties (e.g., its description or summarization); specified or inferred pertinent dates (e.g., deadlines for completing the commitment or request); relevant responses such as initial replies or follow-up messages and their expected timing (e.g., per expectations of courtesy or around efficient communications for task completion among people or per an organization); and information resources to be used to satisfy the request. Such information resources, for example, may provide information about time, people, locations, and so on. The identified task content and inferences about the task content may be used to drive automatic (e.g., computer generated) services such as reminders, revisions (e.g., and displays) of to-do lists, appointments, meeting requests, and other time management activities. In some examples, such automatic services may be applied during the composition of a message (e.g., typing an email or text), reading the message, or at other times, such as during offline processing of email on a server or client device. The initial extraction and inferences about a request or commitment may also invoke automated services that work with one or more participants to confirm or refine current understandings or inferences about the request or commitment and the status of the request or commitment based, at least in part, on the identification of missing information or of uncertainties about one or more properties detected or inferred from the communication.

In some examples, task content may be extracted from multiple forms of communications, including digital content capturing interpersonal communications (e.g., email, SMS text, instant messaging, phone calls, posts in social media, and so on) and composed content (e.g., email, note-taking and organizational tools such as OneNote® by Microsoft Corporation of Redmond, Wash., word-processing documents, and so on).

As described below, some example techniques for identifying and extracting task content from various forms of electronic communications may involve language analysis of content of the electronic communications, which human annotators may annotate as containing commitments or requests. Human annotations may be used in a process of generating a corpus of training data that is used to build and to test automated extraction of commitments or requests and various properties about the commitments or requests. Techniques may also involve proxies for human-generated labels (e.g., based on email engagement data or relatively sophisticated extraction methods). For developing methods used in extraction systems or for real-time usage of methods for identifying and/or inferring tasks or commitments and their properties, analyses may include natural language processing (NLP) analyses at different points along a spectrum of sophistication. For example, an analysis having a relatively low-level of sophistication may involve identifying key words based on simple word breaking and stemming An analysis having a relatively mid-level of sophistication may involve consideration of larger analyses of sets of words (“bag of words”). An analysis having a relatively high-level of sophistication may involve sophisticated parsing of sentences in communications into parse trees and logical forms. Techniques for identifying and extracting task content may involve identifying attributes or “features” of components of messages and sentences of the messages. Such techniques may employ such features in a training and testing paradigm to build a statistical model to classify components of the message. For example, such components may comprise sentences or the overall message as containing a request and/or commitment and also identify and/or summarize the text that best describes the request and/or commitment.

In some examples, techniques for extraction may involve a hierarchy of analysis, including using a sentence-centric approach, consideration of multiple sentences in a message, and global analyses of relatively long communication threads. In some implementations, such relatively long communication threads may include sets of messages over a period of time, and sets of threads and longer-term communications (e.g., spanning days, weeks, months, or years). Multiple sources of content associated with particular communications may be considered. Such sources may include histories and/or relationships of/among people associated with the particular communications, locations of the people during a period of time, calendar information of the people, and multiple aspects of organizations and details of organizational structure associated with the people.

In some examples, techniques may directly consider requests or commitments identified from components of content as representative of the requests or commitments, or may be further summarized. Techniques may extract other information from a sentence or larger message, including relevant dates (e.g., deadlines on which requests or commitments are due), locations, urgency, time-requirements, task subject matter (e.g., a project), and people. In some implementations, a property of extracted task content is determined by attributing commitments and/or requests to particular authors of a message. This may be particularly useful in the case of multi-party emails with multiple recipients, for example.

Beyond text of a message, techniques may consider other information for extraction and summarization, such as images and other graphical content, the structure of the message, the subject header, length of the message, position of a sentence or phrase in the message, date/time the message was sent, and information on the sender and recipients of the message, just to name a few examples. Techniques may also consider features of the message itself (e.g., the number of recipients, number of replies, overall length, and so on) and the context (e.g., day of week). In some implementations, a technique may further refine or prioritize initial analyses of candidate messages/content or resulting extractions based, at least in part, on the sender or recipient(s) and histories of communication and/or of the structure of the organization.

In some examples, techniques may include analyzing features of various communications beyond a current communication (e.g., email, text, and so on). For example, techniques may consider interactions between or among commitments and requests, such as whether an early portion of a communication thread contains a commitment or request, the number of commitments and/or requests previously made between two (or more) users of the communication thread, and so on.

In some examples, techniques may include analyzing features of various communications that include conditional task content commitments or requests. For example, a conditional commitment may be “If I see him, I'll let him know.” A conditional request may be “If the weather is clear tomorrow, please paint the house.”

In some examples, techniques may include augmenting extracted task content (e.g., commitments and/or requests) with additional information such as deadlines, identification (e.g., names, ID number, and so on) of people associated with the task content, and places that are mentioned in the task content.

In some examples, a computing system may construct predictive models for identifying and extracting requests and commitments and related information using machine learning procedures that operate on training sets of annotated corpora of sentences or messages (e.g., machine learning features). In other examples, a computing system may use relatively simple rule-based approaches to perform extractions and summarization.

In some examples, a computing system may explicitly notate task content extracted from a message in the message itself. In various implementations, a computing system may flag messages containing requests and commitments in multiple electronic services and experiences, which may include products or services such as revealed via products and services provided by Windows®, Cortana®, Outlook®, Outlook Web App® (OWA), Xbox®, Skype®, Lync® and Band®, all by Microsoft Corporation, and other such services and experiences from others. In various implementations, a computing system may extract requests and commitments from audio feeds, such as from phone calls or voicemail messages, SMS images, instant messaging streams, and verbal requests to digital personal assistants, just to name a few examples.

The preparation event identifier 220 can also utilize data from a user profile 240 that to generate task reminders in combination with the user-specific model. The user profile 240 can include detailed information about the user, such as the user's relationship to other users and the names and online or electronic identification information for the related users. For example, the knowledge base may identify a user's spouse, parents, children, coworkers, neighbors, or other groups of people. The user-specific knowledge base may also include information about the user's interests, activities, and other relevant information. The user-specific data store can include a user's home location and frequent locations visited, such as shopping locations, restaurants, entertainment locations, and such. The user-specific data store can include information about the user's work location and hierarchical job information, such as the user's manager and who directly reports to the user. Hierarchical work information can help identify whether a task is important as well as its urgency. For example, an apparent request from the user's manager may be more urgent and important than a request received from a coworker.

The user profile 240 can also include communication histories between people. The communication histories can quantify various communication characteristics that can help identify tasks and establish ideal reminder times. The communication characteristics can include a number of messages received from a person, number of messages sent to a person, frequency of response to a person, and average response time to a person. As example, the average response time could be used to set a time to present a reminder for a task of responding a message. The response frequency could be used to determine whether a request to respond to a message should be listed as a task.

User profile 240 includes user accounts and activity 242, user devices 244, organizational profile 246, and user patterns 248. User account(s) and activity data 242 generally includes user data collected from data collection component 202 (which in some cases may include crowd-sourced data that is relevant to the particular user) or other semantic knowledge about the user. In particular, user account(s) and activity data 242 can include data regarding user emails, texts, instant messages, calls, and other communications; social network accounts and data, such as news feeds; online activity; calendars, appointments, or other user data that may have relevance for determining meeting patterns, attendance models, or related meeting information; user availability; and importance, urgency, or notification logic. Embodiments of user account(s) and activity data 242 may store information across one or more databases, knowledge graphs, or data structures. In one example, user account(s) and activity data 242 may be determined using calendar information from one or more user calendars, such as office calendars, personal calendars, social media calendars, or even calendars from family members or friends of the user, in some instances. Moreover, some embodiments of the disclosure may construct a complementary or shadow calendar for a user, as described herein, which may be stored in user account(s) and activity data 242. As discussed hereinabove, user devices 244 may include data elements produced by user devices 102a-102b including, but not limited to, real-time user-device location data and past user-device location data related to prior meetings.

Organizational profile 246 may include organizational data related to the user (title, role, hierarchy, etc.). Organizational data may comprise any data relating to the user, particularly within the context of a the user's place of work, including an organizational group or department, an area of expertise or specialization, frequent contacts, networks (including business-related social networks or connections), and reporting relationships, among others. User patterns 248 may include information relating to the user and meeting patterns, behavior, or models. For example, as will be discussed in more detail below, meeting preparation patterns for the user determined by the meeting association component 226 may be stored in user patterns 246a and/or 246b.

Features similarity identifier 224 is generally responsible for determining similarity of features of two or more meetings (put another way, features characterizing a first meeting that are similar to features characterizing a second meeting). The features may include features relating to contextual information and features determined by semantic information analyzer 232. Meetings having in-common features may be used to identify meeting patterns, which may be determined using meeting pattern determiner 236.

For example, in some embodiments, features similarity identifier 234 may be used in conjunction with meeting pattern determiner 236 to determine a set of meetings that have in-common features. In some aspects, such as the example embodiment shown in meeting preparation system 200, meeting pattern determiner 236 includes a participant specific meeting pattern determiner 236a and a global meeting patterns determined 236b. In some embodiments, this set of meetings may be used as inputs to a pattern-based predictor, as described below. In embodiments where features have a value, similarity may be determined among different features having the same value or approximately the same value, based on the particular feature.

In some embodiments, meeting pattern determiner 236 provides a pattern of meeting and an associated confidence score regarding the strength of the meeting pattern, which may reflect the likelihood that a future meeting will follow the pattern. More specifically, in some embodiments, a corresponding confidence weight or confidence score may be determined regarding a determined meeting pattern. The confidence score may be based on the strength of the pattern, which may be determined based on the number of observations (of a particular meeting) used to determine a pattern, how frequently the user's actions are consistent with the pattern, the age or freshness of the activity observations, the number of similar features, types of features, and/or degree of similarity of the features in common with the activity observations that make up the pattern, or similar measurements.

In some embodiments, a minimum confidence score may be needed before using the pattern. In one embodiment, a threshold of 0.6 (or just over fifty percent) is utilized such that only patterns having a 0.6 (or greater) likelihood of predicting a meeting pattern may be provided. Nevertheless, where confidence scores and thresholds are used, determined patterns of meeting with confidence scores less than the threshold still may be monitored and updated based on additional activity observations, since the additional observations may increase the confidence for a particular pattern.

Some embodiments of meeting pattern determiner 236 determine a pattern according to the example approaches where each instance of a meeting has corresponding historical values of tracked activity features (variables) that form patterns, and where meeting pattern determiner 236 may evaluate the distribution of the tracked variables for patterns. It will be appreciated that, conceptually, the following can be applied to different types of historical values for tracked activity features (variables).

Having determined that a pattern exists, or that the confidence score for a pattern is sufficiently high (e.g., satisfies a threshold value), meeting pattern determiner 236 may identify that a plurality of preparation activities corresponds to a meeting pattern for the user. As a further example, meeting pattern determiner 236 may determine that a meeting preparation pattern is likely to be followed by a user where one or more of the confidence scores for one or more tracked variables satisfy a threshold value.

In some embodiments, patterns of meeting may be determined by monitoring one or more activity features, as described previously. These monitored activity features may be determined from the user data described previously as tracked variables or as described in connection to data collection component 202. In some cases, the variables can represent context similarities and/or semantic similarities among multiple user actions (activity events). In this way, patterns may be identified by detecting variables or features in common over multiple user actions. More specifically, features associated with a first user action may be correlated with features of a second user action to determine a likely pattern. An identified feature pattern may become stronger (i.e., more likely or more predictable) the more often the meeting observations that make up the pattern are repeated. Similarly, specific features can become more strongly associated with a meeting pattern as they are repeated.

The meeting association component 226 looks for similarities between preparation events and meetings and associates the two. The association can be based on conformity with observed patterns.

Turning now to FIG. 3 a meeting preparation interface 340 is shown, in accordance with an aspect of the technology described herein. The meeting preparation interface 340 is activated by hovering the pointer 320 over the “tech team beta review” meeting 310 scheduled for 9 o'clock on the daily calendar 300. The time bar 305 indicates when the meetings occur. Other meetings include, “lunch with Joshua” 312, “meeting with company B” 314, and “project A kickoff” 316. The preparation interface 340 includes a title section 322, and attendee section 324, and a meeting preparation section 330. The meeting preparation section 330 lists three tasks along with associated progress. The first task 332 is reading feedback. The first task is 50% complete. The second task 334 is to generate a next step slide set, which is not been started. The third task 336 is to update a graphical user interface, which is 100% complete. In one aspect, the user can update the progress by clicking on the task. The completion could be measured automatically by monitoring electronic tasks such as reading a feedback document. In one aspect, the preparation record can be selected to open a document associated with completing the preparation event. For example, a user could select on the “read feedback” text to open the feedback document.

Turning now to FIG. 4 a meeting preparation interface 400 is illustrated, in accordance with an aspect of the technology described herein. While the previous meeting preparation interface 400 was associated with a single meeting, the meeting preparation interface 400 includes preparation events for multiple meetings. In one aspect, selecting a meeting, such as the project team A meeting 422 will filter the interface to only preparation events associated with the selected meeting. Similarly, selecting a due date could filter to events due on the selected date.

The preparation events of view includes a description of the event 410, a description of the meeting associated with the event 412, the due date for the event 414, the owner of the event 416, and the status of the event 418. The owner is the person responsible for completing the event. Though not shown, events could have multiple owners. The status indicates how much progress has been made towards completing the event.

The first preparation event 420 is to generate an agenda 421 for the project team a meeting 422 scheduled for 423 Jul. 2, 2018. The due date 424 for the first preparation event is Jul. 1, 2018. The owner 426 of the first event is Sally. The status 428 of the first event is 50% complete. The second preparation event 430 is to email an agenda 431 for the project team a meeting 432 scheduled for 433 Jul. 2, 2018. The due date 434 for the first preparation event is Jul. 1, 2018. The owner 436 of the first event is Sally. The status 438 of the first event is 50% complete. The third preparation event 440 is to generate a slide deck 441 for the company a meeting 442 scheduled for 443 Jul. 3, 2018. The due date 444 for the first preparation event is Jul. 3, 2018. The owner 446 of the first event is John. The status 448 of the first event is 50% complete.

In this example, John is viewing the interface 400. When preparation events are assigned to a person viewing the interface then a block time button 450 may be presented. The block time button 450 creates a calendar entry prior to the preparation event due date to allow John to complete the slide deck. The duration of the time block can be based on the amount of time is taken John to prepare a slide deck for similar meetings. John may be asked to confirm the time slot and duration selected.

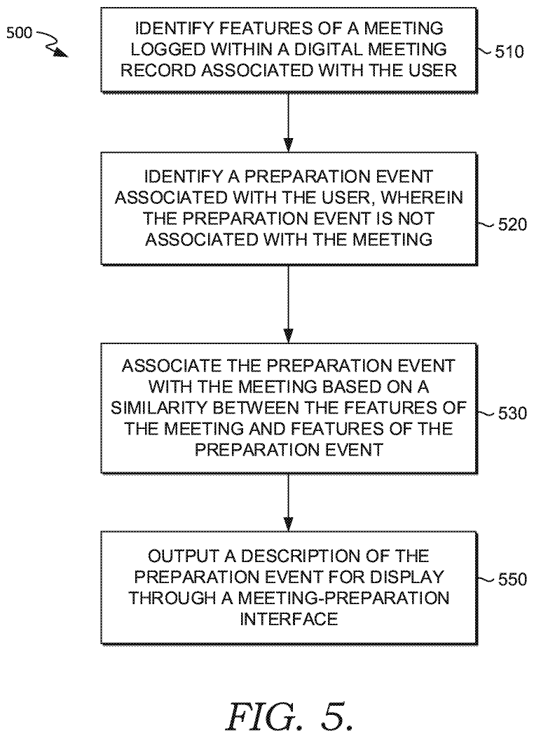

Turning now to FIG. 5, a method 500 for preparing a user for a meeting is provided.

At step 510, features of a meeting logged within a digital meeting record associated with the user are identified. By way of example, features relating to a time and day of the meeting, a meeting subject, a meeting organizer, attendees, invitees, among others, may be detected from the meeting digital meeting record (e.g., meeting invitation).

At step 520, a preparation event associated with the user is identified. The preparation event is not associated with the meeting when the identification occurred. A meeting preparation event that is not yet assigned to a specific meeting may be described as a potential preparation event. The preparation event will be evaluated, possibly along with other identified preparation events, to see if the user should perform the preparation event to prepare for a particular meeting.

As a first step, preparation events can be identified independently of any particular meeting. For example, tasks from one or more applications that track tasks can be identified. Communications can be monitored and analyzed to identify commitments and requests. The collected tasks, commitments, and requests can form a group of potential preparation events. In aspects, the potential preparation events can be output to users apart from any meetings.

At step 530, the preparation event is associated with the meeting based on a similarity between the features of the meeting and features of the preparation event. The plurality of potential preparation events can be analyzed to determine which are associated with meetings and which are not. The potential preparation events that are associated with meetings are actual preparation events. The features of the preparation event can be compared to the features of a meeting to associate the preparation event with a particular meeting. For example, a commitment in an email to attendees of a meeting may be associated with the meeting even though the meeting is not specifically mentioned in the email. In this example, the correlation between the meeting invitees and email recipients is used to link the commitment to the meeting. In addition to the attendees, a subject matter similarity analysis can be performed to associate an email with the meeting. For example, if keywords from the title of a meeting are found in an email then an association between the email and the meeting may be made. Having an email linked to a meeting, the commitments found in the email can be linked to the meeting. In some cases, a communication may have partial information about a meeting, such as a time or location without other meeting details. For example, a text message saying, “please mail the agenda for our 2 o'clock meeting” may be used to associate the request with a meeting occurring at 2 o'clock that has both the author and recipient of the text message.

In one aspect, machine learning is used to associate a communication, and the preparation events extracted from it, with a meeting by analyzing the similarity between the communication and meeting features. A similarity score may be generated for each of several features, such as subject lines, body text, people in common, etc. In one aspect, multiple similarity scores are combined to form a final similarity score. A similarity threshold can be used to determine a communication (and preparation events associated with the communication) are associated with a meeting.

At step 540, a description of the preparation event is output for display through a meeting-preparation interface. Exemplary meeting-preparation interfaces are provided with reference to FIGS. 3 and 4.

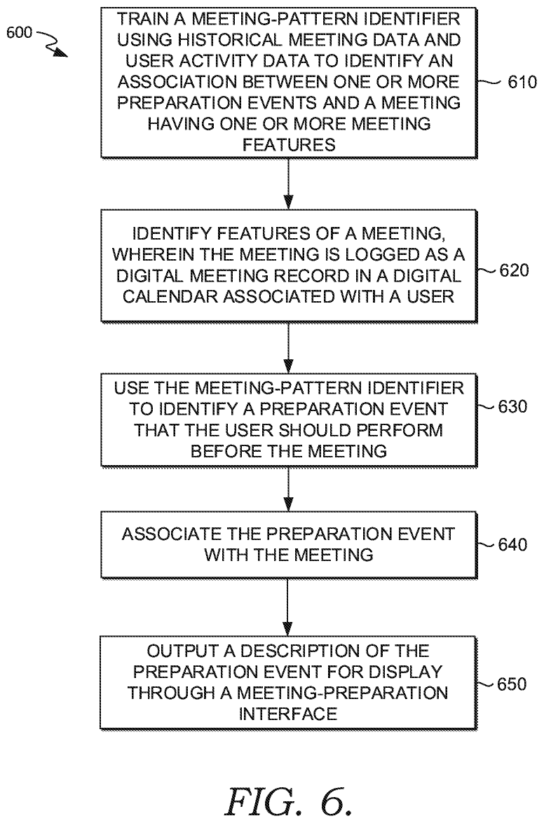

Turning now to FIG. 6, a method 600 for preparing a user for a meeting is provided.

At step 610, a meeting-pattern identifier is trained using historical meeting data and user activity data to identify an association between one or more preparation events and a meeting having one or more meeting features. In some embodiments, a meeting pattern determiner provides a pattern of meeting and an associated confidence score regarding the strength of the meeting pattern, which may reflect the likelihood that a future meeting will follow the pattern. More specifically, in some embodiments, a corresponding confidence weight or confidence score may be determined regarding a determined meeting pattern. The confidence score may be based on the strength of the pattern, which may be determined based on the number of observations (of a particular meeting) used to determine a pattern, how frequently the user's actions are consistent with the pattern, the age or freshness of the activity observations, the number of similar features, types of features, and/or degree of similarity of the features in common with the activity observations that make up the pattern, or similar measurements.

In some embodiments, a minimum confidence score may be needed before using the pattern. In one embodiment, a threshold of 0.6 (or just over fifty percent) is utilized such that only patterns having a 0.6 (or greater) likelihood of predicting a meeting pattern may be provided. Nevertheless, where confidence scores and thresholds are used, determined patterns of meeting with confidence scores less than the threshold still may be monitored and updated based on additional activity observations, since the additional observations may increase the confidence for a particular pattern.

Some embodiments a pattern is determined where each instance of a meeting has corresponding historical values of tracked activity features (variables) that form patterns, and where the distribution of the tracked variables may be analyzed for patterns. In the following example, a tracked variable for a meeting is a time stamp corresponding to an observed instance of the meeting.

Having determined that a pattern exists, or that the confidence score for a pattern is sufficiently high (e.g., satisfies a threshold value), meeting pattern determiner 236 may identify that a plurality of preparation activities corresponds to a meeting pattern. As a further example, a meeting pattern is likely to be followed where one or more of the confidence scores for one or more tracked variables satisfy a threshold value.

In some embodiments, patterns of meeting may be determined by monitoring one or more activity features, as described previously. These monitored activity features may be determined from the user data and/or meeting described previously as tracked variables or as described in connection to data collection component 202. In some cases, the variables can represent context similarities and/or semantic similarities among multiple user preparation actions (activity events). In this way, patterns may be identified by detecting variables or features in common over multiple user actions. More specifically, features associated with a first user action may be correlated with features of a second user action to determine a likely preparation pattern with meetings having certain features. An identified feature pattern may become stronger (i.e., more likely or more predictable) the more often the meeting observations that make up the pattern are repeated. Similarly, specific features can become more strongly associated with a meeting pattern as they are repeated.

At step 620, features of a meeting are identified. The meeting is logged as a digital meeting record in a digital calendar associated with a user. The meeting is not part of the training data.

At step 630, the meeting-pattern identifier is used to identify a preparation event that the user should perform before the meeting. The preparation patterns and meeting patterns can be mined to form rules that can be specific to an organization, group of people, or the public in general. The rules can be used to associate preparation events with a meeting.

The rules can be scenario specific. For example, certain rules can be built for reoccurring meetings. For example, the timing of an email related to a series of meetings can be used to associate a preparation event within the email to a particular meeting in the series. Using this rule a commitment in an email sent after a meeting in the series has started (i.e., you are either in the meeting or that meeting has ended), then any task/commitment in the email may be inferred to be relevant to the next meeting in the series. So if a participant emails a promise to send a meeting summary during a meeting, the technology can associate the commitment with the next meeting. Further, the due date for this commitment can be determined based on the distribution timing of previous meeting summaries in this series of meetings.

Another scenario involves using an email in a thread to generate a meeting invitation, as enabled by some current email applications. In this case, the commitments and requests in the thread can be associated with the meeting. In one aspect, a proximity threshold is used when the email thread spans more than a week of time, or some other limit In this case, only requests and commitments made within emails sent within the threshold are associated with the new meeting.

In another scenario, when an email's recipients and sender are all of the participants in an upcoming meeting, then the commitments and requests in the email are associated with the meeting.

At step 640, the preparation event is associated with the meeting.

At step 650, a description of the preparation event is output for display through a meeting-preparation interface. Exemplary meeting-preparation interfaces are provided with reference to FIGS. 3 and 4.

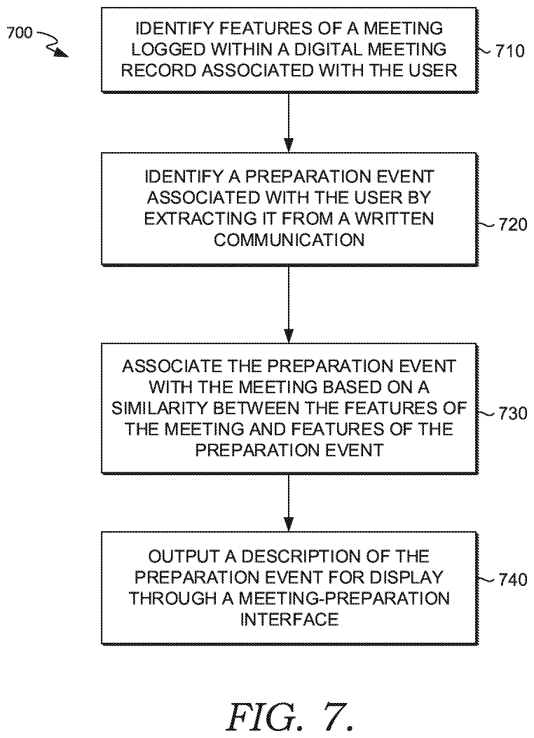

Turning now to FIG. 7, a method 700 for preparing a user for a meeting is provided.

At step 710, features of a meeting logged within a digital meeting record associated with a user are identified. By way of example, features relating to a time and day of the meeting, a meeting subject, a meeting organizer, attendees, invitees, among others, may be detected from the meeting digital meeting record (e.g., meeting invitation).

At step 720, a potential preparation event associated with the user is identified by extracting it from a written communication. For example, the preparation event could be a commitment or request that is extracted from a written communication as described previously.

At step 730, the potential preparation event is associated with the meeting based on a similarity between the features of the meeting and features of the potential preparation event. The features of the potential preparation event can be derived from the written communication.

At step 740, a description of the potential preparation event is output for display through a meeting-preparation interface. Exemplary meeting-preparation interfaces are provided with reference to FIGS. 3 and 4.

### Exemplary Computing Environment

With reference to FIG. 8, computing device 800 includes a bus 810 that directly or indirectly couples the following devices: memory 812, one or more processors 814, one or more presentation components 816, one or more input/output (I/O) ports 818, one or more I/O components 820, and an illustrative power supply 822. Bus 810 represents what may be one or more busses (such as an address bus, data bus, or combination thereof). Although the various blocks of FIG. 8 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 8 is merely illustrative of an exemplary computing device that can be used in connection with one or more aspects of the present technology. Distinction is not made between such categories as “workstation,” “server,” “laptop,” “handheld device,” etc., as all are contemplated within the scope of FIG. 8 and with reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer-storage media and communication media.

Computer-storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 800. Computer storage media does not comprise signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors 814 that read data from various entities such as memory 812 or I/O components 820. Presentation component(s) 816 presents data indications to a user or other device. Exemplary presentation components include a display device, speaker, printing component, vibrating component, and the like.

The I/O ports 818 allow computing device 800 to be logically coupled to other devices, including I/O components 820, some of which may be built in. Illustrative components include a microphone, joystick, game pad, satellite dish, scanner, printer, wireless device, etc.

The I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

Some aspects of computing device 800 may include one or more radio(s) 824 (or similar wireless communication components). The radio 824 transmits and receives radio or wireless communications. The computing device 800 may be a wireless terminal adapted to receive communications and media over various wireless networks. Computing device 800 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

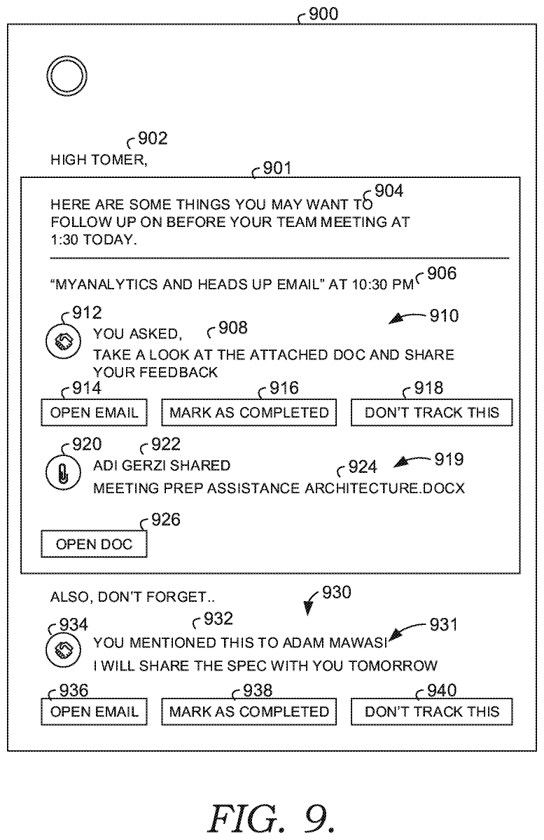

Turning now to FIG. 9, a diagram of a meeting preparation interface 900 is provided, in accordance with aspects of the technology described herein. The preparation interface 900 may be accessed via a calendar entry or pop-up calendar reminder, automatically surfaced by a personal assistant, or through some other mechanism. The preparation interface 900 includes a preparation section 901 and related actions 930 section. The preparation section 901 describes various items related to meeting preparation, such as tasks the user may wish to complete before the meeting, resources the user may need in the meeting, and the like. Each item may include a link to relevant resources, identify the source of the item, identify a person the item originated with, and/or convey additional information. The preparation interface 900 also includes a user personalization in the form of a salutation 902.

The preparation section 901 includes a message 904 indicating the items are related to a specific team meeting occurring today at 1:30. The message can be formed by inserting meeting details such as time, location, and subject, into a message template. The preparation section 901 includes two items. The first item 910 is a request reminder originating in “my analytics and heads up email” 906. The request icon 912 can indicate the first item 910 is a request. Different icons can be associated with different types of items. The request message 908 indicates, “you asked, take a look at the attached DOC and share your feedback.”

The first item 910 also includes an open email control 914, a mark as completed control 916, and a don't track this control 918. The open email control 914 will take the user to the “My Analytics and Heads Up Email” from which the request was extracted. The email may be opened in a separate user interface. The mark as completed control 916 will cause the task associated with the first item to be marked as completed within the meeting preparation system. As described previously, the meeting preparation system can track meeting preparation events for multiple meetings. Upon receiving a selection of the completed control 916, the first item 910 may be removed from the preparation section 901. The first item 910 may be moved to a completed item interface (not shown). The completed item interface may show preparation tasks the user, and optionally other attendees, has completed. The don't track this control 918 will also cause the first item 910 to be removed from the preparation section 901. Selection of the don't track this control 918 may also be used as feedback to retrain components that select preparation events to show to a user. Once retrained, the relevant components will be less likely to display similar tasks on the preparation interface 900.

The second item 919 is an attachment the user may wish to review prior to the meeting. The source of the second item 919 is indicated as, “Adi Gerzi” 922. The name of the document is provided as, “Meeting Prep Assistant Architecture.DOCX” 924. The second item 919 is associated with an attachment icon 920. The Meeting Prep document may be opened through the Open Doc control 926. The document may be opened in a separate interface associated with a document processing application.

The related actions section 930 includes additional actions that may be related to the meeting. In one aspect, the related actions section 930 includes actions to help others prepare for the meeting, while the meeting preparation section 901 includes actions the user needs to complete. In another aspect, the related action section 930 includes items with a lower association strength to the meeting. In other words, the items in the related action section 930 may be less likely to be necessary for preparation for an upcoming meeting than items in the preparation section 901. The third item 931 includes the commitment icon 934, a description 932, an open email control 936, a mark as completed control 938, and a don't track this control 940.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility, may be employed without reference to other features and sub-combinations, and are contemplated within the scope of the claims.

What is claimed is:

1. A method for preparing a user for a meeting, comprising:
identifying features of a meeting logged within a digital meeting record associated with the user;
identifying a preparation event associated with the user, wherein the preparation event is not associated with the meeting within a meeting preparation system;
associating the preparation event with the meeting based on a similarity between the features of the meeting and features of the preparation event; and
outputting a description of the preparation event for display through a meeting-preparation interface.

2. The method of claim 1, wherein the digital meeting record comprises meeting details, and wherein the meeting details and the preparation event are displayed simultaneously.

3. The method of claim 1, wherein the preparation event is a user commitment extracted from an email and the commitment is a not associated with a due date when extracted, wherein the method further comprises:
calculating an estimated amount of time needed for the user to complete the preparation event; and
assigning a start date and time to the preparation event that is based on the estimated amount of time and a start date and time of the meeting.

4. The method of claim 3, wherein the method further comprises outputting for display a notification for the preparation event at the start date and time.

5. The method of claim 1, wherein the preparation event is a user request extracted from an email, wherein the meeting is one in a series of meetings and the email is sent after a start of a preceding meeting in the series.

6. The method of claim 1, wherein the meeting-preparation interface displays an additional meeting preparation event for the user to perform in preparation for a second meeting.

7. The method of claim 1, wherein a meeting preparation model is used to associate the preparation event with the meeting, wherein the meeting preparation model is a machine-learning model trained using historical meeting records and user activities.

8. A method for meeting preparation, comprising:
training a meeting-pattern identifier using historical meeting data and user activity data to identify an association between one or more preparation events and a meeting having one or more meeting features;
identifying features of a meeting, wherein the meeting is logged as a digital meeting record in a digital calendar associated with a user;
using the meeting-pattern identifier to identify a preparation event that the user should perform before the meeting;
associating the preparation event with the meeting; and
outputting a description of the preparation event for display through a meeting-preparation interface.

9. The method of claim 8, wherein the preparation event is not an extracted request or commitment and the preparation event is not a user created task.

10. The method of claim 8, wherein the meeting-pattern identifier is trained to be specific to the user.

8. The method of claim 8, wherein the meeting-pattern identifier is trained to be specific to an organization.

9. The method of claim 8, wherein a confidence factor calculated by the meeting-pattern identifier for the preparation event is above a threshold.

10. The method of claim 12, wherein the confidence factor increased in response to activity of other users attending the meeting.

11. The method of claim 8, further comprising:
calculating an estimated amount of time needed for the user to complete the preparation event; and
assigning a start date and time to the preparation event that is based on the estimated amount of time and a start date and time of the meeting.

12. The method of claim 8, wherein the meeting-pattern identifier is a machine-learning model that builds association rules.

13. One or more computer storage media that, when executed by a computing device, causes the computing device to perform a method of identifying meeting preparation tasks, the method comprising:
identifying features of a meeting logged within a digital meeting record associated with a user;
identifying a preparation event associated with the user by extracting it from a written communication;
associating the preparation event with the meeting based on a similarity between the features of the meeting and features of the preparation event; and
outputting a description of the preparation event for display through a meeting-preparation interface.

14. The media of claim 13, wherein the meeting is between only the user and a second person, and wherein the preparation event is associated with the second person through the written communication.

15. The media of claim 13, wherein the meeting is between only the user and a second person, wherein all commitments made by the user to the second person and all requests made of the user by the second person are added as preparation events for the meeting.

16. The media of claim 13, wherein the preparation event is associated with the meeting because the written communication is a response to a meeting request for the meeting.

17. The media of claim 13, wherein the preparation event is a user request extracted from an email, wherein the meeting is one in a series of meetings and the email is sent after a start of a preceding meeting in the series.
